(19) United States
(12) Patent Application Publication
(10) Pub. No.: US 2020/0001362 A1
(43) Pub. Date: Jan. 2, 2020

(54) Pressure-Welded Tool

(71) Applicant: CSM Maschinen GmbH, Landsberg am Lech (DE)

(72) Inventor: Helmut Schuster, Landsberg am Lech (DE)

(73) Assignee: CSM Maschinen GmbH, Landsberg am Lech (DE)

(21) Appl. No.: 16/461,775

(22) PCT Filed: Nov. 9, 2017
(86) PCT No.: PCT/EP2017/078736

§ 371 Date: Sep. 16, 2019

(30) Foreign Application Priority Data
Nov. 16, 2016 (DE) 10 2016 122 063.9

(51) Int. Cl. B22F 3/00; B22F 3/10

(52) U.S. Cl. CPC B22F 3/008; B23B 51/02; B22F 3/10

(57) ABSTRACT

The present invention discloses a pressure-welded tool, wherein the method for manufacturing pressure-welded tool includes: heating a first joining surface of a first metal part carrying a tool head to a temperature above the recrystallization temperature of the first metal part; heating a second joining surface of a second metal part to a temperature above the recrystallization temperature of the second metal part; and end-to-end pressure welding together the heated first joining surface and the heated second joining surface until the temperatures of the first joining surface and the second joining surface cool down to below their respective recrystallization temperatures; accordingly a tool is manufactured using the above method.

### BACKGROUND OF THE INVENTION

### (a) Field of the Invention

The present invention relates to a pressure-welded tool.

### (b) Description of the Prior Art

According to German Patent No. DE102009036285 A1, it is known that among tools with a tool head, a welding method can be used to join together the tool head and a tool thread member. Moreover, the Japanese Patent No. JP52-50906A discloses a tool manufacturing method under an anaerobic or inert gas environment, however, according to the method disclosed, it is clearly understood that all machined parts must be placed in an anaerobic or inert gas environment.

### SUMMARY OF THE INVENTION

The object of the present invention lies in improving the above-described known manufacturing method.

According to one aspect of the present invention, a tool manufacturing method includes the following steps: heating a first joining surface of a first metal part carrying a tool head to a temperature above the recrystallization temperature of the first metal part; heating a second joining surface of a second metal part to a temperature above the recrystallization temperature of the second metal part; end-to-end pressure welding together the heated first joining surface of the first metal part and the heated second joining surface of the second metal part until the temperatures of the first joining surface and the second joining surface have dropped to below their respective recrystallization temperatures. Furthermore, the above-described pressure welding step of the first metal part and the second metal part eliminates the diffusion sintering method under an anaerobic or inert gas environment of the prior art.

The basic concept of the present invention lies in the necessity to fittingly join together the above-described first metal part carrying the tool head with the above-described second metal part provided with a thread to manufacture a tool with an operating torque that functions in coordination with a drilling tool. In contrast, welding seams of inadequate stability to provide a torque with sufficient mechanical resistance is unable to ensure safe and long-lasting operation. This problem appears in tools such as screwdrivers and tap wrenches.

Hence, in the present invention, pressure welding is used to join together the first metal part and the second metal part and not the common welding method. Advantages of pressure welding include the ability to completely and uniformly join together the first metal part and the second metal part; moreover, material identical to the first metal part and the second metal part can be used therebetween, which is similar to classical welding. Hence, using such a pressure welding method eliminates the need to carry out additional joining technology (such as shape matching joining) on the first metal part and the second metal part, while still being able to achieve an adequate operating torque for the tool.

According to the above-described method for one improvement scenario, the first metal part undergoes sintering prior to heating the first joining surface thereof. Accordingly, the first metal part can be adapted to the application function of the tool to achieve an optimal state.

For example, the first metal part provided with a tool head can undergo sintering, especially for a tool head structure of a tool for use with stone and concrete. If traditional cutting production technology (such as milling) suitable for helix symmetrical parts is used as the manufacturing method, then low cost production is only achieved under certain conditions. However, it is also not ideal to manufacture the entire tool using a sintering method. Hence, separate manufacturing of the first metal part and the second metal part of the tool and final pressure welding to join together the two metal parts enables achieving the optimal method of manufacturing both the first metal part and the second metal part, while keeping production and manufacturing costs low to finally join together the first metal part and the second metal part.

Furthermore, the first metal part can also be manufactured using other firsthand molding techniques, such as 3D printing (also known as incremental manufacturing), the advantage of which is that numerous different alloy materials can be chosen to manufacture the tool head, thereby enabling achieving the ideal tool head according to its functional needs. In particular, 3D printing techniques is completely open to choice regarding the selection of alloy materials.

According to the above specific improvement scenario of the present invention, the method further includes the following steps: prior to heating the second joining surface of the second metal part, the second metal part is prepared using a type of cutting technology, such as milling, to cut out a tool thread on a housing layer of the second metal part.

According to an additional improvement scenario of the present invention, the method further includes the following steps: heating another second joining surface of the second metal part opposite to the second joining surface that is connected to the first metal part to a temperature above the recrystallization temperature thereof; heating a third joining surface of a third metal part to a temperature above the recrystallization temperature thereof; end-to-end pressure welding together the heated second joining surface of the second metal part and the heated third joining surface of the third metal part until the temperatures of the second joining surface and the third joining surface have dropped to below their respective recrystallization temperatures.

When using the described tool, the third metal part can serve as a connecting member, which adopts a “Special Direct System” (abbreviated to SDS) mechanistic embodiment to enable connectively connecting the connecting member to a tool receiver. Similar as the first metal part, the third metal part can be prepared using sintering technology.

According to another aspect of the present invention, the type of tool manufactured using the above-described method include tools such as drill heads, screwdrivers, and tap wrenches.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of a drilling tool.

FIG. 2 is a schematic view of a tool for the drilling tool depicted in FIG. 1.

FIG. 3A is a schematic view of the pressure welding process between a first metal part and a second metal part of the tool for the drilling tool depicted in FIG. 2 according to the present invention.

FIG. 3A′ is a schematic view of burrs formed after the pressure welding process between the first metal part and the second metal part of the tool for the drilling tool shown in FIG. 3A.

FIG. 3B is a schematic view of a laser path of the pressure welding process of the first metal part and the second metal part of the tool for the drilling tool shown in FIG. 3A.

FIG. 3C is a laser light energy input key diagram with the passage of time for the first metal part and the second metal part of the tool for the drilling tool shown in FIG. 3B.

### DETAILED DESCRIPTION OF THE PREFERRED EMBODIMENTS

In the attached drawings, identical technical components consistently use identical number symbols as markings, and each type of technical component is only described once. In addition, the attached drawings are purely schematic views and do not reflect actual geometric relationships between the objective components.

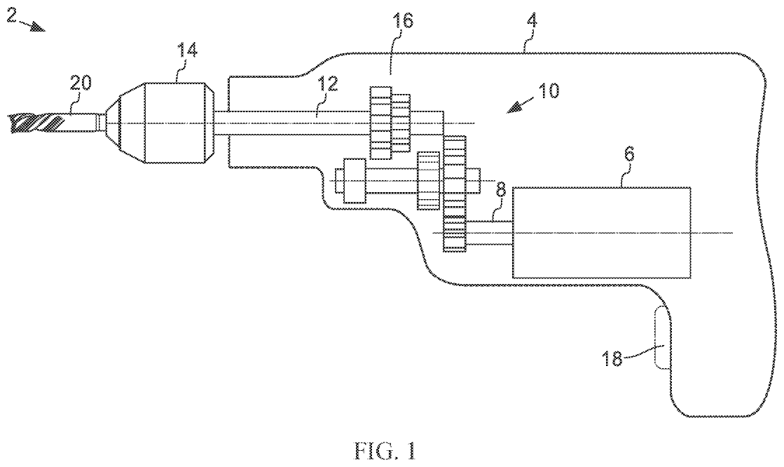

Referring to FIG. 1, which shows a drilling tool 2 as an example of an implementation of the present invention, wherein a tool 20 is a processing tool, and the drilling tool 2 includes a housing 4 depicted by the dotted line. The interior of the housing 4 is provided with a motor 6 that is used to drive a drive shaft 8, which further drives an output shaft 12 through a known drive device 10. A chuck 14 is installed on another end of the output shaft 12 relative to the drive device 10, and axial displacement 16 of the output shaft 12 enables setting different transmission ratios for the drive device 10.

The motor 6 rotates the drive shaft 8, which connectively drives and rotates the output shaft 12 through the drive device 10, thereby rotating the chuck 14. A switch 18 is installed on the drilling tool 2 and is used to start the motor 6 to activate rotation. The functional operation of the drilling tool 2 is basically known prior art, and thus a specific description is not provided herein.

The chuck 14 clamps the tool 20, with FIG. 1 only showing a portion of the tool 20. The tool 20 rotates along with the chuck 14 and can be used to drill holes in raw material (not shown in the drawings).

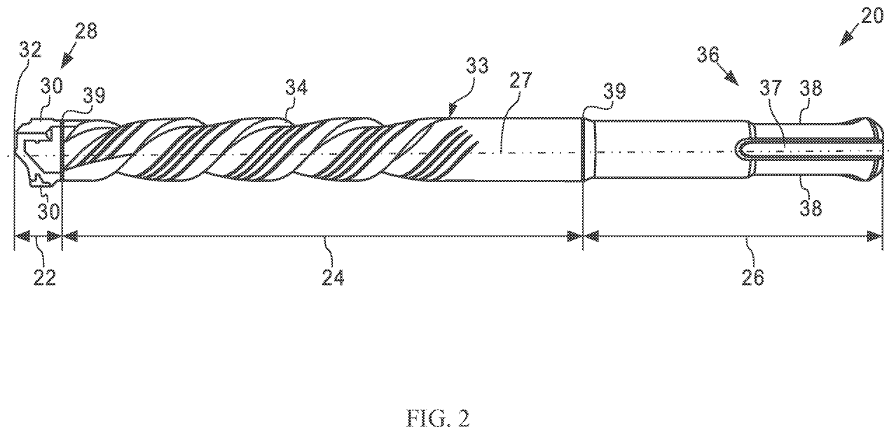

Regarding the tool 20, FIG. 2 provides a detailed representation thereof.

The tool 20 includes a first metal part 22, a second metal part 24 fixed to the first metal part 22, and a third metal part 26 fixed to the second metal part 24. The first metal part 22 and the third metal part 26 are respectively positioned on the two ends of the second metal part 24. The first metal part 22, the second metal part 24, and the third metal part 26, overall, form a rod shaped body with a rotational symmetry distribution along a rotating shaft 27.

A tool head 28 is disposed on the end of the first metal part 22, wherein the tool head 28 is structured from two chisel edges 30 and one tool tip 32. During a drilling process, the tool tip 32 compresses material while centering the tool 20 thereon, and the two chisel edges 30 rotate along with the rotating tool 20 to shave away material to form a drill hole.

A tool thread 34 is cut into a housing layer 33 of the rod shaped body of the central second metal part 24, which enables the chisel edges 30 to expel material shavings shaved away from a drill hole during a drilling process, thus clearing a space for shaving away new material shavings in the drill hole. Using such a method, the tool 20 is able to continuously penetrate into the raw material.

A connecting member 36 is disposed on the third metal part 26, and the tool 20 is fixed inside the chuck 14 by means of the connecting member 36. The design of the connecting member 36 depends upon what type of chuck 14 is fixed to a machine tool, and in the present embodiment, the connecting member 36 adopts a “Special Direct System” (abbreviated to SDS) mechanistic embodiment. In order to securely fix the tool 20 using such a mechanism, the connecting member 36 includes two guide grooves 37 respectively located on two sides of the rotating shaft 27; only one of the guide grooves 37 can be seen in FIG. 2. In addition, the connecting member 36 further includes two locking grooves 38 respectively located on two sides of the rotating shaft 27. When inserting the tool 20 into the chuck 14 of the drilling tool 2, the two guide grooves 37 slide on two guide edges (not shown in the drawings) that guide the tool 20 to insert therein. When the tool 20 has been inserted to a sufficient depth, two locking members in the chuck 14 (not shown in the drawings) embed into the locking grooves 38, thereby locking the tool 20. The “Special Direct System” mechanism itself is known prior art, and thus a specific description is not provided herein.

When manufacturing the tool 20, a sintering or 3D printing method must first be used to manufacture the first metal part 22 and the third metal part 26. Accordingly, the tool head 28, in particular, will easily have the ability to drill a hole in stone or concrete of high mechanical hardness. By contrast, the manufacturing method of the second metal part 24 differs from the manufacturing methods of the first metal part 22 and the third metal part 26, wherein a cutting method (such as milling) is used to form the tool thread 34 in the housing layer 33 of the round bar shaped body of the second metal part 24. Using such a method enables achieving low cost manufacturing of an undercut formed tool thread, which would otherwise prove difficult using a sintering method. With regard to the tool head 28, the advantage of using 3D printing technology lies in that there is, basically, no limit in the choice of raw material or alloy that can be used.

Finally, the first metal part 22, the second metal part 24, and the third metal part 26, having been manufactured using the above-described methods, are joined together using pressure welding, with the addition of a welding seam 39 as a reinforcing join.

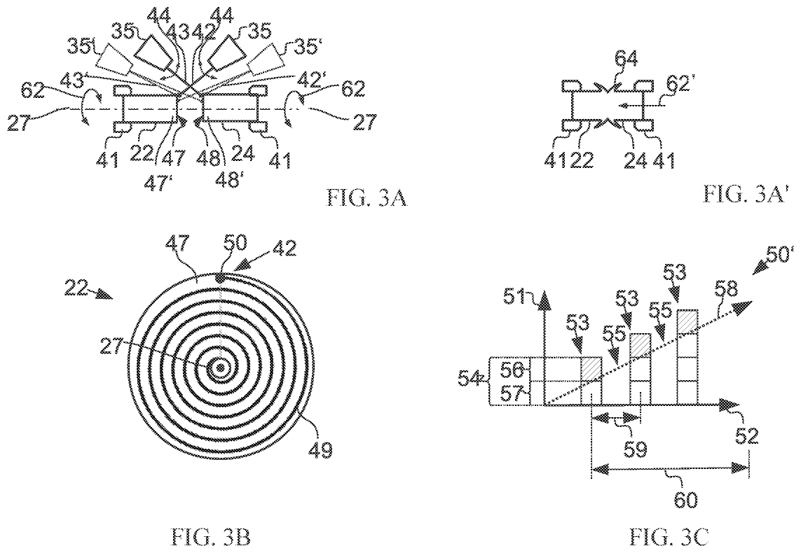

Regarding a viable pressure welding method of the first metal part 22, the second metal part 24, and the third metal part 26, a description thereof, with the help of FIGS. 3A to 3C, is provided below using a detailed description of the joining between the first metal part 22 and the second metal part 24 as an example.

During the pressure welding process, the first metal part 22 and the second metal part 24 needs to be respectively clamped using clamping heads 41, after which the first metal part 22 is heated using a first laser beam 42 and the second metal part 24 is heated using a second laser beam 43. The first laser beam 42 and the second laser beam are respectively produced from laser generators 35 of the known prior art.

In the pressure welding operation of the first metal part 22 and the second metal part 24, the first laser beam 42 and the second laser beam 43 operate in a crossed fashion, as depicted in FIG. 3A, that is, the first laser beam 42 heats the first metal part 22 and the second laser beam 43 heats the second metal part 24, thus, the first metal part 22 is provided with a first joining portion 47′ and a first joining surface 47; and the second metal part 24 is provided with a second joining portion 48′ and a second joining surface 48. In FIG. 3A, the first joining surface 47 and the second joining surface 48 of the first metal part 22 and the second metal part 24, respectively, are directly heated and press welded together.

Regarding heating of the first joining surface 47 and the second joining surface 48, the two laser generators 35 must be first accurately aligned with the respective first metal part 22 and the second metal part 24, the objective of which is to prevent scanning ranges 44 of the laser generators 35 from covering areas of the first metal part 22 and the second metal part 24 that should not be heated, thus, the first metal part 22 and the second metal part 24 avoid blocking the second laser beam 43 and the first laser beam 42, respectively. In FIG. 3A, the dotted line portion and the number symbols marked with an apostrophe are used to illustrate the positions of laser generators 35′, on these positions of which the first metal part 22 and the second metal part 24 mutually block portions of the scanning ranges 44 of the second laser beam 43′ and the first laser beam 42′ of the laser generators 35′.

After completing positioning of the laser generators 35, the laser scanning process begins, at which time, the laser generators 35 are correctly aligned with the first metal part 22 and the second metal part 24, and the first laser beam 42 and the second laser beam 43 are used to irradiate the first joining surface 47 of the first metal part 22 and the second joining surface 48 of the second metal part 24, respectively, whereupon, the first joining surface 47 and the second joining surface 48 are heated to temperatures above the recrystallization temperatures thereof. The recrystallization temperatures depend on the materials themselves, for example: steel tools have a recrystallization temperature approximately between 600° C. to 700° C., and more specifically depends on the alloy composition and structural state. However, the first joining surface 47 and the second joining surface 48 of the first metal part 22 and the second metal part 24, respectively, cannot be heated to temperatures above the melting points thereof, otherwise, the first metal part 22 and the second metal part 24 could possibly undergo local damage, thereby impacting the pressure welding process.

In order to ensure comprehensive heating of the first joining surface 47 and the second joining surface 48 of the first metal part 22 and the second metal part 24, respectively, curvilinear movements of the first laser beam 42 and the second laser beam 43 of the laser generators 35 within the scanning ranges 44 are needed while irradiating the first joining surface 47 and the second joining surface 48. In other words, corresponding movements of the first laser beam 42 and the second laser beam 43 are made relative to the respective first joining surface 47 and the second joining surface 48 thereof. Corresponding movements can also be actualized by only moving the first metal part 22 and the second metal part 24, or moving the laser beams 42, 43 at the same time as moving the first metal part 22 and the second metal part 24. In order to actualize the above-described corresponding movements, the first metal part 22 and the second metal part 24 rotate along the rotating shaft 27 to perform a rotary motion 62, as depicted in FIG. 3A.

FIG. 3B shows a helical curve, which serves as an example of the above-mentioned curvilinear movement, wherein the helical curved path is formed from scanning and irradiating the first joining surface 47 of the first metal part 22 with the first laser beam 42. Accordingly, the first joining surface 47 is heated by irradiating with the first laser beam 42. The first laser beam 42 produced by the laser generator 35 moves along a helical curve 49 and heats the first joining surface 47. In principle, movements of the first laser beam 42 and the second laser beam 43 are not an absolute requirement; if the focal points of the first laser beam 42 and the second laser beam 43 are large enough (not shown in the drawings) to completely cover the first joining surface 47 and the second joining surface 48, respectively, without moving the first laser beam 42 and the second laser beam 43, the laser beams 42, 43 can still carry out heating the first joining surface 47 and the second joining surface 48 of the first metal part 22 and the second metal part 24, respectively, to temperatures above their respective recrystallization temperatures.

A heating situation analysis directed to a heated point 50 is described below, wherein the heated point 50 is a certain point located on the helical curve 49 and can be heated by the first laser beam 42 when the first laser beam 42 performs helical scanning on the firs joining surface 47 of the first metal part 22. Here, the heating situation analysis can be divided into three stages. And with the help of FIG. 3C, a detailed description is provided below, wherein FIG. 3C shows a plot of heat energy 51 of the heated point 50 versus time 52. The plot is labeled with the number symbol 50′ in FIG. 3C.

When the first laser beam 42 irradiates the heated point 50 on the first joining surface 47, the heated point 50 is in a heating period 53. During the heating period 53, the heated point 50 on the first joining surface 47 is heated and has a heat energy gain 54. Three heating periods 53 are show in FIG. 3C, which means that the first laser beam 42 scans along the helical curve 49 three times and irradiates the heated points 50 three times as well. The heat energy gain 54 is only indicated with number symbols in the first heating period 53 of FIG. 3C. When the first laser beam 42 irradiates the points other than the heated point 50 along the helical curve 49, the heated point 50 enters a cooling period 55 and starts cooling off, which causes a heat energy loss 56. In order to achieve an effective heating objective of the heated point 50, when the first laser beam 42 has completed scanning along the helical curve 49, an energy difference value 57 between the heat energy gain 54 and the heat energy loss 56 must be a positive value, only then can an effective heating 58 of the entire first joining surface 47 be achieved. The effective heating 58 is represented as a broad dotted line arrow in FIG. 3C.

Total duration of one heating period 53 and one cooling period 55 is named as an energy superposition duration 59 hereinafter. The reciprocal of the energy superposition duration 59 is named energy superposition frequency, which represents the speed of the movement of the first laser beam 42 along the helical curve 49. And total duration of the heating periods 53 and the cooling periods 55 is named heating time 60 hereinafter.

When the temperatures of all points on the first joining surface 47 along the helical curve 49 are above the recrystallization temperature of the first metal part 22, then the heating time 60 is adequate. The heating or heating method on the second joining surface 48 is identical to that carried out on the first joining surface 47.

When the first joining surface 47 and the second joining surface 48 of the first metal part 22 and the second metal part 24, respectively, have been heated to temperatures above the recrystallization temperatures thereof, a pressing device presses the first metal part 22 and the second metal part 24 together in a pressing direction 62′, as depicted in FIG. 3A′, until the first metal part 22 and the second metal part 24 cool down to below their respective recrystallization temperatures. After which, burrs 64 may possibly form on the joining portion of the first metal part 22 and the second metal part 24; however, the burrs 64 can be removed by machining methods.

After mechanical joining of the first metal part 22 and the second metal part 24, the same procedural method is used to press weld together the third metal part 26 and the second metal part 24 to complete the manufacturing of the tool 20.

Apart from using laser pressure welding technology, inductance pressure welding, forge welding, contact welding, friction welding, resistance welding, and ultrasonic welding can also be used to join together the first metal part 22, the second metal part 24, and the third metal part 26.

In summary, the above description of the embodiments provides a clear understanding of the operational procedure and the effectiveness achieved by the present invention. However, it is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A method for manufacturing pressure-welded tool, comprising the following steps:
heating a first joining surface of a first metal part carrying a tool head to a temperature above a recrystallization temperature of the first metal part;
heating a second joining surface of a second metal part to a temperature above a recrystallization temperature of the second metal part;
end-to-end pressure welding together of the heated first joining surface of the first metal part and the heated second joining surface of the second metal part until the temperatures of the first joining surface and the second joining surface have dropped to below the recrystallization temperatures thereof;
whereby the pressure welding step of the first metal part and the second metal part eliminates the diffusion sintering method under an anaerobic or inert gas environment.

2. The method for manufacturing pressure-welded tool according to claim 1, wherein sintering is first carried out on the first metal part prior to heating the first joining surface of the first metal part.

3. The method for manufacturing pressure-welded tool according to claim 1, wherein the first metal part provided with the tool head is prepared and formed using a 3D printing method.

4. The method for manufacturing pressure-welded tool according to claim 2, wherein the second metal part is first formed by cutting manufacturing technology before the second joining surface thereof is heated.

5. The method for manufacturing pressure-welded tool according to claim 4, wherein the cutting manufacturing technology is a milling method, which is used to mill a tool thread in a housing layer of the second metal part.

6. The method for manufacturing pressure-welded tool according to claim 4, further comprising: heating another second joining surface of the second metal part to a temperature above the recrystallization temperature thereof, wherein the another second joining surface is on the other end of the second metal part opposite the end thereof for connection to the first joining surface of the first metal part; heating a third joining surface of a third metal part to a temperature above a recrystallization temperature thereof; and end-to-end pressure welding together the heated another second joining surface of the second metal part and the heated third joining surface of the third metal part until the temperatures of the another second joining surface and the third joining surface have dropped to below the recrystallization temperatures thereof.

7. The method for manufacturing pressure-welded tool according to claim 6, wherein sintering is first carried out on the third metal part prior to heating the third joining surface of the third metal part.

8. The method for manufacturing pressure-welded tool according to claim 7, wherein the third metal part includes a connecting member for fixing a tool into a chuck.

9. The method for manufacturing pressure-welded tool according to claim 3, wherein the second metal part is first formed by cutting manufacturing technology before the second joining surface thereof is heated.

10. The method for manufacturing pressure-welded tool according to claim 9, wherein the cutting manufacturing technology is a milling method, which is used to mill a tool thread in a housing layer of the second metal part.

11. The method for manufacturing pressure-welded tool according to claim 9, further comprising, heating another second joining surface of the second metal part to a temperature above the recrystallization temperature thereof, wherein the another second joining surface is on the other end of the second metal part opposite the end thereof for connection to the first joining surface of the first metal part; heating a third joining surface of a third metal part to a temperature above a recrystallization temperature thereof; and end-to-end pressure welding together the heated another second joining surface of the second metal part and the heated third joining surface of the third metal part until the temperatures of the another second joining surface and the third joining surface have dropped to below the recrystallization temperatures thereof.

12. The method for manufacturing pressure-welded tool according to claim 11, wherein sintering is first carried out on the third metal part prior to heating the third joining surface of the third metal part.

13. The method for manufacturing pressure-welded tool according to claim 12, wherein the third metal part includes a connecting member for fixing a tool into a chuck.

14. A pressure-welded tool, wherein the tool is manufactured using the method for manufacturing pressure-welded tool according to claim 1.

15. The pressure-welded tool according to claim 14, wherein the tool is a drill head, a screwdriver, or a tap wrench.
